(19) United States
(12) Patent Application Publication
(10) Pub. No.: US 2011/0120615 A1
(43) Pub. Date: May 26, 2011

(54) RADIATION-CROSSLINKABLE FOAMED SELF-ADHESIVE BASED ON VINYLAROMATIC BLOCK COPOLYMERS

(75) Inventors: Franziska Zmarsly, Hamburg (DE); Thorsten Krawinkel, Hamburg (DE); Axel Burmeister, Buchholz (DE); Sabine Thormeier, Hamburg (DE)

(73) Assignee: tesa SE, Hamburg (DE)

(21) Appl. No.: 12/994,503

(22) PCT Filed: Nov. 2, 2009
(86) PCT No.: PCT/EP2009/064444

§ 371 Date: Feb. 1, 2011

(30) Foreign Application Priority Data
Nov. 12, 2008 (DE) 10 2008 056 980.1

(51) Int. Cl. B29C 65/52

(52) U.S. Cl. 156/60

(57) ABSTRACT

Self-adhesive consisting of a mixture having at least one tackifier resin, expanded polymeric microbeads and a polymer blend made up of thermoplastic and/or non-thermoplastic elastomers with at least one vinylaromatic block copolymer containing a fraction of more than 30% by weight of 1,2-linked diene in the elastomer block.

This is a 371 of PCT/EP2009/064444 filed 2 Nov. 2009 (international filing date), and claims the priority of German Application No. 10 2008 056 980.1, filed on 12 Nov. 2008.

The invention relates to a radiation-crosslinkable, foamed self-adhesive based on vinylaromatic block copolymers.

### BACKGROUND OF THE INVENTION

A large number of double-sided self-adhesive tapes with a polymer foam core are known that are used for bonding in different areas of application, such as the bonding of moldings to bodies in the automobile sector, or the attachment of Plexiglas trim.

A feature of polymer foam cores comprising a foamed polymer matrix is that their density is less than that of the unfoamed polymer matrix. This density reduction can be achieved in a variety of ways, such as, for example, by means of hollow glass or polymer bead fillers, by means of physical foaming using carbon dioxide, or by means of the addition of expandable polymer beads.

The double-sided self-adhesive tapes typically possess a polymer foam core, consisting, for example, of polyethylene, polyurethane or polyvinyl chloride, and two self-adhesives attaching to the foam core.

For applications where redetachment of the adhesive tape is desired and/or necessary, this three-layer construction is disadvantageous, since the forces that act during the detachment process may result in the splitting of the foam or in adhesive fracture between the adhesive/polymer foam boundary layer.

The effect of a very low density of the polymer foam core used, composed of PE or PU, for example, is a low cohesion in the foam matrix. Consequently, the capacity of the polymer foam core to withstand permanent high shearing loads which act on the bonded product is inferior, meaning that there is a high risk of the foam splitting within itself.

Pressure-sensitive adhesives (PSAs) based on styrene block copolymers feature high bond strengths (as a result of the simultaneous realization of very high cohesion and very high bond strengths) and also feature very high tensile strengths, which are essential in particular for a tear-free detachment process.

The products on the market that utilize PSAs based on styrene block copolymers exhibit weaknesses in bonding strength at temperatures above 50° C. A softening of the hard phases (block polystyrene domains) which consist principally of polystyrene has the effect, especially in the bonding of moderately heavy articles, of the cohesive failure of the pressure-sensitive adhesive strips.

Failure of the bond occurs under pure shearing load, and particularly under a tipping shear load, where a torque is active.

WO 93/24547 A1 and WO 97/29140 A1 describe styrene block copolymers which are crosslinkable and hence possess a better temperature stability than conventional styrene block copolymers. Also described are self-adhesives comprising such polymers, but these adhesives must be coated or extruded onto a carrier.

DE 21 05 877 C highlights an adhesive tape composed of a carrier which is coated on at least one side with a microcellular, pressure-sensitive adhesive and where the layer of adhesive comprises a nucleating agent, the cells of the layer of adhesive being closed and being distributed completely within the layer of adhesive. This adhesive tape is able to conform to the irregular surface to which it is applied, and is therefore able to result in a relatively durable bond, but on the other hand exhibits poor recovery following compression to half of the original thickness. The cavities within the adhesive offer opportunities for lateral ingress of solvents and water into the bondline, which is highly undesirable. Moreover, the complete passage of solvents or water through the entire adhesive tape cannot be ruled out.

EP 0 257 984 A1 discloses adhesive tapes which at least on one side have a foamed adhesive coating. Contained within this adhesive coating are polymer beads which in turn contain a hydrocarbon liquid and expand at elevated temperatures. The scaffold polymers of the self-adhesives may be composed of rubbers or polyacrylates. The hollow microbeads here are added either before or after polymerization. The self-adhesives comprising microballoons are processed from solvent and shaped to adhesive tapes. The foaming step takes place strictly after coating. In this way, microscopically rough surfaces are obtained. This results in properties such as, in particular, nondestructive redetachability and repositionability. The effect of the better repositionability through microscopically rough surfaces of microballoon-foamed self-adhesives is also described in other specifications such as DE 35 37 433 A1 or WO 95/31225 A1.

The microscopically rough surface is used in order to produce a bubble-free bond. This use is also disclosed by EP 0 693 097 A1 and WO 98/18878 A1.

The advantageous properties of the microscopically rough surface, however, are always countered by a significant reduction in the bonding strength and/or the peel strength. DE 197 30 854 A1, therefore, proposes a carrier layer which is foamed with microballoons and which, for the purpose of avoiding the loss of bonding strength, proposes the use of unfoamed pressure-sensitive self-adhesives above and below a foamed core.

### SUMMARY OF THE INVENTION

It is an object of the invention to unite or combine an improved self-adhesive based on vinylaromatic or styrene block copolymers with the advantageous properties of a polymer matrix foamed with expanded microballoons.

This object is achieved with a generic self-adhesive as described hereinbelow.

### DETAILED DESCRIPTION

The invention accordingly provides a self-adhesive composed of a mixture comprising:
a polymer blend of thermoplastic and/or non-thermoplastic elastomers with at least one vinylaromatic block copolymer which contains a fraction of more than 30% by weight of 1,2-linked diene in the elastomer block
at least one tackifier resin
expanded polymeric microbeads.

Suitable vinylaromatics include all substituted and unsubstituted aromatics that contain vinyl groups. Examples of suitable vinylaromatics are styrene, alpha-methylstyrene, vinyltoluene, p-tert-butylstyrene or p-methyl-alpha-methylstyrene, but especially styrene.

The vinylaromatic or styrene block copolymer described can be crosslinked in the elastomer block by electron beams and/or UV rays.

The crosslinking of this foamed self-adhesive may take place, for example, via ultraviolet irradiation or with the aid of electron beams. It has been found that this radiation-crosslinking allows the cohesive properties of the foamed self-adhesive at high temperatures to be improved, with retention at the same time of the adhesive-bonding properties.

For the polymer blends, advantageously, the non-thermoplastic elastomer is selected from the group of natural rubbers or synthetic rubbers, or is composed of any desired blend of natural rubbers and/or synthetic rubbers, it being possible for the natural rubber or natural rubbers to be selected in principle from all available grades such as, for example, crepe, RSS, ADS, TSR or CV types, depending on required level of purity and of viscosity, and for the synthetic rubber or synthetic rubbers to be selected from the group of randomly copolymerizable styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or blends thereof.

For the polymer blends, advantageously, the thermoplastic elastomer is selected from the group of styrene block copolymers and especially the styrene-isoprene-styrene (SIS) and styrene-butadiene-styrene (SBS) types, or else from the group of polyacrylates.

Microballoons are elastic hollow beads which have a thermoplastic polymer shell. These beads are filled with low-boiling liquids or liquefied gas. Shell materials used include more particularly polyacrylo-nitrile, PVDC, PVC or polyacrylates. Suitable low-boiling liquids are, in particular, hydrocarbons of the lower alkanes, isobutane or isopentane, for example, which are enclosed as a liquefied gas under pressure in the polymer shell.

Exposure of the microballoons to an effect, particularly an exposure to heat, causes softening of the outer polymer shell. At the same time, the liquid propellant within the shell undergoes transition to its gaseous state. The microballoons expand irreversibly and three-dimensionally. Expansion is at an end when the internal pressure equals the external pressure. Since the polymeric shell is retained, a closed-cell foam is thus obtained.

A large number of types of microballoon are available commercially, such as, for example, from Akzo Nobel, the Expancel DU (dry unexpanded) types, which differ essentially in their size (6 to 45 μm diameter in the unexpanded state) and in the initiating temperature they require for expansion (75 to 220° C.). When the type of microballoon and the foaming temperature have been harmonized with the machine parameters and with the temperature profile required for compounding, then compounding and foaming may also take place simultaneously in one step.

Also available are unexpanded microballoon types in the form of an aqueous dispersion having a solids fraction or microballoon fraction of 40% to 45% by weight, and, additionally, polymer-bonded microballoons (masterbatches), in ethyl-vinyl acetate, for example, with a microballoon concentration of 65% by weight. Like the DU types, both the microballoon dispersions and the masterbatches are suitable for the foaming of adhesives of the invention.

According to one preferred embodiment of the invention, the fraction of the microballoons in the adhesive prior to expansion is between greater than 0% and 30% by weight, more particularly between 1.5% and 10% by weight.

With further preference the microballoons at 25° C. have a diameter of 3 μm to 40 μm, more particularly 5 μm to 20 μm, and/or, following temperature exposure, have a diameter of 20 μm to 200 μm, more particularly 40 μm to 100 μm.

As a result of this capacity for volume enlargement, the incorporation and homogeneous distribution of the microballoons within a polymer matrix is able to lower the resulting density, following microballoon activation, considerably, to down to 150 kg/m³.

In addition to the reduction in density, the foaming of the self-adhesive of the invention also has particular properties, such as an increased cohesion on the part of the polymer matrix, providing for residue-free redetachment of the adhesive tape. By further radiation-crosslinking of the foamed self-adhesive tape, moreover, the stability and shear strength at elevated temperature >50° C. are also improved.

Tackifier resins which can be used as a main component, for example, in the self-adhesive include, in particular, hydrogenated and nonhydrogenated hydrocarbon resins and polyterpene resins. Those that are preferably suitable include hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc. or Arkon P series; Arakawa). These resins may come through hydrogenation of polymers from pure aromatics streams, or else may be based, through hydrogenation of polymers, on mixtures of different aromatics. Also suitable are partially hydrogenated polymers of C₈ and C₉ aromatics (for example, Regalite and Regalrez series; Eastman Inc. or Arkon M; Arakawa), hydrogenated polyterpene resins (for example, Clearon M; Yasuhara), hydrogenated C₅/C₉ polymers (for example, ECR-373; Exxon Chemicals), aromatics-modified, selectively hydrogenated dicyclopentadiene derivatives (for example, Escorez 5600 series; Exxon Chemicals). The aforementioned tackifier resins may be used both alone and in a mixture.

Hydrogenated hydrocarbon resins are particularly suitable as a blending component for crosslinkable styrene block copolymers, as described in EP 0 447 855 A1, U.S. Pat. No. 4,133,731 A, and U.S. Pat. No. 4,820,746 A, for example, since the absence of double bonds means that there can be no disruption to crosslinking.

Furthermore, however, nonhydrogenated resins can be used as well if crosslinking promoters, such as polyfunctional acrylates, for example, are used.

Particularly preferred under these conditions is the use of terpene resins based on α-pinene (Piccolyte A series from Hercules, Dercolyte A series from DRT), since these resins, in addition to high cohesion, also ensure very high adhesion even at high temperatures.

Use may also be made, however, of other nonhydrogenated hydrocarbon resins, nonhydrogenated analogues of the hydrogenated resins described above. As a result of the preferred use of crosslinking promoters, it is likewise possible to use rosin-based resins. On account of their low adhesion at elevated temperatures, they are primarily used only as blending components.

The fraction of the tackifier resins, based on the total adhesive, according to one advantageous embodiment, is between 20% and 70% by weight, more particularly between 40% and 60% by weight.

For stabilizing the PSA it is usual to add primary antioxidants such as, for example, sterically hindered phenols, secondary antioxidants such as, for example, phosphites or thioethers and/or C radical scavengers.

Further additives which can be used are, customarily, light stabilizers such as, for example, UV absorbers and sterically hindered amines, antiozonants, metal deactivators, processing assistants, and endblock-reinforcing resins.

Plasticizers such as, for example, liquid resins, plasticizer oils or low molecular mass liquid polymers, such as low molecular mass polyisobutylenes, for example, having molar masses of less than 1500 g/mol (number average), or liquid EPDM types, can be used in small amounts of less than 20% by weight.

Fillers such as, for example, silicon dioxide, glass (ground or in the form of beads), aluminum oxides, zinc oxides, calcium carbonates, titanium dioxides, carbon blacks, etc., and also color pigments and dyes, and also optical brighteners, may likewise be used.

For increasing the radiation yield, use is optionally made of crosslinking promoters for the electron beam crosslinking. Examples of crosslinking promoters which can be used include crosslinking promoters based on polyfunctional acrylates or thiols. In the case of UV crosslinking it is necessary to use UV crosslinkers such as Irgacure 651 from Ciba Geigy, for example.

In another advantageous embodiment of the subject matter of the invention, the radiation-crosslinkable, foamed self-adhesive may be processed further to a double-sided adhesive tape, by shaping the self-adhesive in web form, onto a liner, for example, which is removed before the adhesive tape is adhered.

In this context it is possible to produce both thin 40 μm and thick foams up to 3000 μm in a single-layer construction.

The thickness of the self-adhesive in an adhesive tape on a carrier material in web form is preferably between 20 μm and 3000 μm, with particular preference between 40 μm and 150 μm, or, applied to a release material, 20 μm to 2000 μm.

In a further advantageous embodiment of the subject matter of the invention, the radiation-crosslinkable, foamed self-adhesive may also be used as a single-sided pressure-sensitive adhesive tape, by coating this adhesive onto a carrier material.

The general expression “adhesive tape” for the purposes of this invention encompasses all sheetlike structures such as two-dimensionally extended sections, tapes with extended length and limited width, tape sections and the like, and also, lastly, diecuts or labels.

The adhesive tape may be produced either in the form of a roll, in other words rolled up onto itself in the form of an Archimedean spiral, or lined with release materials such as siliconized paper or siliconized film.

As carrier material it is possible to use all known carriers, for example such as laid, woven, knitted, and nonwoven fabrics, films, papers, tissues, foams, and foamed films. Suitable films are of polypropylene, preferably oriented, polyester, unplasticized and plasticized PVC. Preference is given to polyolefin foam, polyurethane foam, EPDM foam, and chloroprene foam. By polyolefin here is meant polyethylene and polypropylene, with polyethylene being preferred on account of its softness. The term “polyethylene” includes LDPE, and also ethylene copolymers such as LLDPE and EVA. Suitable more particularly are crosslinked polyethylene foams or viscoelastic carriers. The latter are preferably of polyacrylate, more preferably filled with hollow structures of glass or polymers. Before being combined with the adhesive, the carriers may be prepared by priming or by physical pretreatment such as corona.

The foaming of self-adhesives by means of expandable polymeric microbeads allows savings to be made in terms of raw materials costs, specifically on account of the reduction in densities to down to 150 kg/m³ and on account of the single-layer construction of the adhesive tape. The production costs are reduced, moreover, through the increase in coating speeds, since reduced weights per unit area can be used for high coat thicknesses.

For the single-layer article of the invention, moreover, there is no longer any need for any further aftercoating composition in order to produce a double-sided adhesive tape, referred to as a foam fixer, and, furthermore, there is an improvement in redetachability in contrast to a three-layer product with predetermined breakage points at the boundary layer between aftercoating composition and carrier and polymer foam core respectively.

Likewise, advantageous properties arise through the foaming of the self-adhesive, such as, for example, an increase in the cohesion and/or shear strength of the product, the improved bonding strength on rough substrates, or the additional damping quality.

The foaming of a self-adhesive based on radiation-crosslinkable vinylaromatic or styrene block copolymers results in further particular properties such as, for example, the increased bonding strength on low-energy substrates and/or the enhanced thermal stability.

Low-energy surfaces are, among others, those based on fluorine polymers, organosilicon polymers or polyolefins, or based on polymers which comprise fluorine-containing segments, segments comprising organosilicon polymers, or polyolefin segments, or those based on a mixture of aforementioned polymers with or without further polymers.

In terms of its properties, the radiation-crosslinkable, foamed self-adhesive tape of the invention is at least equivalent to the above-mentioned double-sided foam adhesive tapes, and can at the same time be produced more easily and more economically, since the article of the invention consists of a single-layer construction.

### BRIEF DESCRIPTION OF THE DRAWINGS

FIG. 1 shows a foamed, double-sided self-adhesive tape in single-layer construction. The foamed, double-sided self-adhesive tape consists of a layer of a self-adhesive 1, in which the microballoons are already expanded. The self-adhesive 1 is coated onto a release paper 2.

FIG. 2 shows the dependence of the density and also the dependence of the foaming rate on the microballoon content. The higher the microballoon content (x-axis), the lower the achieved foaming rate (y-axis) for constant machine parameters and production parameters in each case.

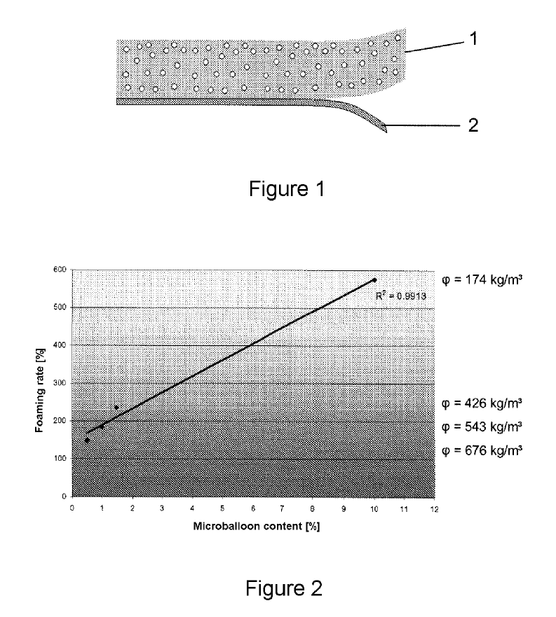

### TEST METHODS

### Peel Strength

### Bond Strength to Steel (BSS))

The peel strength (bond strength) is tested in a method based on PSTC-1.

A strip of the (self-)adhesive tape under investigation is bonded in a defined width (standard: 20 mm) to a polished steel plate by tenfold overrolling with a 5 kg steel roller. Double-sided adhesive tapes are given a reinforcement backing in the form of an unplasticized PVC film 36 μm thick. The plate prepared in this way is clamped into the testing apparatus, the adhesive strip is peeled via its free end at a peel angle of 180° and at a speed of 300 mm/min on a tensile testing machine, and the force required to accomplish this is recorded. The results are reported in N/cm and are averaged over three measurements. All measurements are carried out in an acclimatized room at 23° C. and 50% relative humidity.

### Quantitative Determination of Shear Strength

### Static Shear Test SRT

An adhesive tape is applied to a defined, rigid substrate (in this case steel) and subjected to a constant shearing load. The holding time in minutes is ascertained.

A suitable plate suspension system (angle 179±1°) ensures that the adhesive tape does not peel away from the bottom edge of the plate.

The test is intended primarily to supply information on the cohesiveness of the composition. This is only the case, however, when the weight and temperature parameters are selected such that cohesive failure does in fact occur during the test.

Otherwise, the test provides information on the adhesion to the substrate or on a combination of adhesion and cohesiveness of the composition.

A strip, 13 mm wide, of the adhesive tape under test is adhered to a polished steel plaque (test substrate) over a length of 5 cm by tenfold overrolling with a 2 kg roller. Double-sided adhesive tapes are lined on the reverse with a 50 μm aluminum foil, and hence reinforced. Subsequently a belt loop is mounted to the bottom end of the adhesive tape. A nut and bolt is then used to fasten an adapter plaque to the facing side of the shear test plate, in order to ensure the specified angle of 179±1°.

The time for development of strength, between roller application and loading, shall be between 10 and 15 minutes.

The weights (corresponding to a force of 5 N and 10 N, respectively) are then hung on smoothly with the aid of the belt loop.

An automatic clock counter then determines the point in time at which the test specimens shear off.

### Density

The density of a coated self-adhesive is determined via the ratio of the coatweight to the respective coat thickness:

$$δ = \frac{m}{V} = \frac{CW}{d} [ δ ] = \frac{[ kg ]}{[ {m}^{2} ] \cdot [ m ]} = [ \frac{kg}{{m}^{3}} ]$$

CW=coatweight (excluding weight of carrier) in [kg/m²]
d=coat thickness (excluding thickness of carrier) in [m]

Using a number of examples, the invention is illustrated below, without any intention that these examples should restrict the invention in any way whatsoever.

### EXAMPLES

### Example 1

### Unfoamed SBS

### 1.1.) Adhesive Formula:

| | |
|---|---|
| Styrene-butadiene-styrene block | 49.5% by weight |
| copolymer: Kraton DKX 222 | |
| Poly-α-pinene resin: Dercolyte A115 | 49.5% by weight |
| Octadecyl 3-(3,5-di-tert-butyl-4- | 1.0% by weight |
| hydroxyphenyl)propionate: Irganox 1076 | |

### 1.2.) Production Instructions:

The raw materials identified above were processed to a homogeneous mixture in a heatable compounder with sigma blade (Werner and Pfleiderer LUK 1,0 K3, fitted with an LTH303 thermostat from mgw LAUDA) at a temperature of +160 to +180° C. under blanketing with CO₂ as inert gas. This PSA was subsequently coated in web form via a heatable two-roll calender, crosslinked optionally by means of electron beams at the reported dose, and investigated for its adhesive bonding properties.

### 1.3.) Properties:

TABLE 1
Adhesive bonding properties of the adhesives
of example 1

| | | | | | SRT |
|---|---|---|---|---|---|
| | CW | Thickness | Density | BSS | 70° C. 5N |
| Specimen | [g/m²] | [μm] | [kg/m³] | [N/cm] | [min] |
| uncrosslinked | 960 | 1032 | 930 | 9.1 | 50 |
| 195 kV/60 kGy | 962 | 1035 | 929 | 9.0 | >10 000 |

### Example 2

### Foamed SBS

### 2.1.) Adhesive Formula:

| | |
|---|---|
| Styrene-butadiene-styrene block | 49.5% by weight |
| copolymer: Kraton DKX 222 | |
| Poly-α-pinene resin: Dercolyte A115 | 49.5% by weight |
| Octadecyl 3-(3,5-di-tert-butyl-4- | 1.0% by weight |
| hydroxyphenyl)propionate: Irganox 1076 | |
| Microballoons: Expancel 092 DU 40 | 5.0% by weight |

### 2.2.) Processing:

A continuous mixing assembly such as a planetary roller extruder, for example, was supplied with all of the above-stated raw materials (Kraton DKX 222, Dercolyte A115, Irganox 1076, Expancel 092 DU 40) in corresponding quantity, in the form of granules and/or powder, and this charge was compounded under optimum machine parameters.

The self-adhesive homogenized in this way had a die exit temperature of 109° C., meaning that the microballoons distributed uniformly within the polymer matrix had not yet expanded or at most had undergone partial, preliminary expansion to a low degree.

The shaped extrudates were subsequently introduced into a further mixing assembly such as a single-screw extruder, the microballoons being supplied with the optimum foaming temperature and foaming energy in order to expand at the die exit or on pressure equilibration. The polymer foam was subsequently coated onto a release paper (80 μm) with double-sidedly stepped siliconization, at a thickness of 1000 μm, with the aid of a heatable two-roll calender, and the coated paper was wound up onto a 3′ cardboard core.

With this foam fixer (single-layer, double-sided adhesive tape), a density of 480 kg/m³ was set.

(In contrast, the unfoamed polymer matrix has a density of 920 kg/m³, and hence a mass reduction of around 50% has been achieved.)

This foamed, double-sided self-adhesive tape based on SBS was then crosslinked using electron beams, with different doses, and subsequently investigated for its adhesive bonding properties.

### 2.3.) Properties:

This double-sided self-adhesive foam fixer gave the following properties:

TABLE 2
Adhesive bonding properties of the adhesives of example 2

| | | | | | SRT RT | SRT |
|---|---|---|---|---|---|---|
| | CW | Thickness | Density | BSS | 10N | 70° C. 5N |
| Specimen | [g/m²] | [μm] | [kg/m³] | [N/cm] | [min] | [min] |
| uncross linked | 511 | 1063 | 480 | 8.5 | >10 000 | 44 |
| 195 kV/30 kGy | | | | 8.4 | >10 000 | 121 |
| 195 kV/60 kGy | | | | 8.5 | >10 000 | 2743 |
| 195 kV/90 kGy | | | | 8.7 | >10 000 | >30 000 |

From a comparison of examples 1 and 2 it is clear that the bond strength of the foamed self-adhesive, in comparison to that of the unfoamed adhesive of identical coat thickness and formula, is reduced only by a maximum of 8%.

In example 2, therefore, a self-adhesive tape in single-layer construction has been produced that combines the advantages of a closed-cell foam with high shear strength, without producing a substantial drop in bond strength. This is also true, in particular, at higher temperatures, where no failure is apparent. Furthermore, the adhesive tape of the invention offers the advantages of adhesive tapes with foamed adhesives, such as high conformity of the adhesive to rough substrates, and such as the saving made on adhesive for a given coat thickness.

### Example 3

### Polymer Blend SBS/NR

### 3.1.) Adhesive Formula:

| | |
|---|---|
| Styrene-butadiene-styrene co-block | 22.75% by weight |
| polymer: Kraton DKX 222 | |
| Natural rubber polyisoprene: SVR L | 22.75% by weight |
| Poly-α-pinene resin: Dercolyte A115 | 22.75% by weight |
| Aliphatic hydrocarbon resin: Piccotac | 22.75% by weight |
| 1100-E | |
| Octadecyl 3-(3,5-di-tert-butyl-4- | 1.0% by weight |
| hydroxyphenyl)propionate: Irganox 1076 | |
| Microballoons: Expancel 092 DU 40 | 8.0% by weight |

### 3.2.) Processing: See Example 2.

### 3.3.) Properties:

TABLE 3
Adhesive bonding properties of the adhesives of example 3

| | | | | BSS 90° | SRT steel | SRT steel |
|---|---|---|---|---|---|---|
| | CW | Thickness | Density | 300 mm/min | RT 10N | 70° C. 5N |
| Specimen | [g/m²] | [pm] | [kg/m³] | o.s. [N/cm] | o.s. [min] | o.s. [min] |
| fresh | 368 | 1050 | 350 | 7.9 | >10 000 | 125 |
| 168 kV/30 kGy | | | | 7.7 | | 586 |
| 168 kV/60 kGy | | | | 7.6 | | 675 |
| 168 kV/90 kGy | | | | 7.8 | | >10 000 |

### Example 4

### Polymer Blend SBS/EVA

### 4.1.) Adhesive Formula:

| | |
|---|---|
| Styrene-butadiene-styrene block | 24.5% by weight |
| copolymer: Kraton DKX 222 | |
| Ethylene-vinyl acetate rubber: | 24.5% by weight |
| Levamelt 456 | |
| Glyceryl ester of hydrogenated rosin: | 45.0% by weight |
| Foral 85-E | |
| Octadecyl 3-(3,5-di-tert-butyl-4- | 1.0% by weight |
| hydroxyphenyl)propionate: Irganox 1076 | |
| Microballoons: Expancel 092 DU 40 | 5.0% by weight |

### 4.2.) Processing: See Example 2.

### 4.3.) Properties:

TABLE 4
Adhesive bonding properties of the adhesives of example 4

| | | | | BSS 90° | BSPE 90° | SRT steel | SRT steel |
|---|---|---|---|---|---|---|---|
| | CW | Thickness | Density | 300 mm/min | 300 mm/min | RT 10N | 70° C. 5N |
| Specimen | [g/m²] | [μm] | [kg/m³] | o.s. [N/cm] | o.s. [N/cm] | o.s. [min] | o.s. [min] |
| fresh | 424 | 1010 | 420 | 12.3 | 7.7 | >10 000 | 314 |
| 168 kV/30 kGy | | | | 11.8 | | | 539 |
| 168 kV/60 kGy | | | | 11.9 | | | 896 |
| 168 kV/90 kGy | | | | 11.8 | | | >10 000 |

Examples 3 and 4 as well show a self-adhesive tape produced in single-layer construction, combining the advantages of a closed-cell foam with high shear strength, without producing any substantial drop in bond strength.

1. A self-adhesive composed of a mixture comprising:
a polymer blend of thermoplastic and/or non-thermoplastic elastomers with at least one vinylaromatic block copolymer which contains a fraction of more than 30% by weight of 1,2-linked diene in the elastomer block
at least one tackifier resin; and
expanded polymeric microbeads.

2. The self-adhesive of claim 1, wherein styrene is selected as vinylaromatic.

3. The self-adhesive of claim 1, wherein the fraction of vinylaromatic or styrene block copolymers, based on the total adhesive, is 20% to 70% by weight.

4. The self-adhesive of claim 1, wherein the fraction of the microballoons, based on the total adhesive, prior to expansion, in the self-adhesive is between greater than 0% and 30% by weight.

5. The self-adhesive of claim 1, wherein the fraction of the tackifier resins, based on the total adhesive, is between 20% and 70% by weight.

6. The self-adhesive of claim 1, wherein the self-adhesive comprises further blending components, more particularly plasticizers, ageing inhibitors, processing assistants, fillers, dyes, optical brighteners, stabilizers.

7. The self-adhesive of claim 1, wherein the polymer plasticizer is based on a polyester of phthalic acid, of azelaic acid, of sebacic acid or of adipic acid.

8. The self-adhesive of claim 1, wherein the self-adhesive comprises crosslinking promoters.

9. The self-adhesive of claim 1, wherein the vinylaromatic or styrene block copolymer is crosslinked in the elastomer block by electron beams and/or UV rays.

10. The self-adhesive of claim 1, wherein the density of the self-adhesive following activation of the microballoons drops to down to 150 kg/m³.

11. The self-adhesive of claim 1, wherein the thickness of the self-adhesive in an adhesive tape on a carrier material in web form is between 20 μm and 3000 μm.

12. A method comprising producing a double-sided adhesive tape with the self-adhesive of claim 1, wherein the self-adhesive being in strip form.

13. The method of claim 12, wherein the self-adhesive is applied to a carrier material.

14. The self-adhesive of claim 3, wherein the fraction of vinylaromatic or styrene block copolymers, based on the total adhesive, is 30% to 60%, by weight.

15. The self-adhesive of claim 14, wherein the fraction of vinylaromatic or styrene block copolymers, based on the total adhesive, is 35% to 55%, by weight.

16. The self-adhesive of claim 4, wherein the fraction of the microballoons, based on the total adhesive, prior to expansion, in the self-adhesive is between 1.5% and 10% by weight.

17. The self-adhesive of claim 5, wherein the fraction of the tackifier resins, based on the total adhesive, is between 40% and 60% by weight.

18. The self-adhesive of claim 10, wherein the density of the self-adhesive following activation of the microballoons is situated between 300 and 800 kg/m³.

19. The self-adhesive of claim 11, wherein the thickness of the self-adhesive in an adhesive tape on a carrier material in web form is between 40 μm and 150 μm.

20. The self-adhesive of claim 11, wherein the thickness of the self-adhesive in an adhesive tape on a carrier material in web form is between 20 μm to 2000 μm.
